(19) United States
(12) Patent Application Publication
(10) Pub. No.: US 2010/0100897 A1
(43) Pub. Date: Apr. 22, 2010

(54) Method and system to provide live entertainment digital content to the home viewers

(76) Inventor: Johnson Manuel-Devadoss ("Johson Smith"), Chennai (IN)

Correspondence Address: Johnson Manuel-Devadoss ("Johnson Smith"), 8383 EL MUNDO STREET #307, HOUSTON, TX, 77054, US

(21) Appl. No.: 12/642,409

(22) Filed: Dec. 18, 2009

(51) Int. Cl. H04N 7/16

(52) U.S. Cl. 725/5; 725/110; 725/78; 725/30

(57) ABSTRACT

Disclosed is a system for providing live entertainment at home through interactive display electronic devices like television, personal computer. The system includes web interface components, ticket booking module, billing module, validation module and notification module. The web interface component gathers entities from viewer while booking a ticket for movie/event. The entities include viewer's preferred location to watch the event like if they want to see the event at home or in the theatre/auditorium along with event details, date, time and IP address. The validation module obtains identification credentials, which is 6-digit authentication from a viewer's ticket and validates those credentials. If the ticket credentials are valid, the entity that submitted the credentials is considered an authenticated identity. Once authenticated, the authorization process determines whether that identity has access to the event. After this the live event content streams to viewer's home interactive display device from the theater/auditorium.

### FIELD OF THE INVENTION

The present invention relates generally to the entertainment system, and more particularly, to providing live entertainment at home through interactive display electronic devices like television, personal computer.

### BACKGROUND OF THE INVENTION

In today's world significant importance is given to entertainment. People watch more movies and other forms of events like live non-free stage entertainment show. Movies explore the edges of human emotion, freeze culture and show us how creative we can be. However most people do not preferred to watch the movie in the theater due to a number of reasons. One of the top reasons being privacy—many prefer to avoid the crowd. They like to stay in the comfort of their home and watch entertainment thereby avoiding chatter disturbances from fellow members in the theater/auditorium.

Time constraint also plays as an important cause. Due to predefined event/movie timings in theater/auditorium, people are not able to make it on-time. Sometimes the movies of their choice are shown only once on a particular day, thereby forcing people to make adjustments in their daily schedule to watch the particular event/movie.

Another reason that can be attributed to is climatic conditions. During rainy/snow season, many people miss out on a number of movies/events, as they like to stay warm indoors. People try to avoid travelling to theatre/auditorium during the cold weather season. Due to this movie revenue is affected and it causes great loss for the movie producers and as well as the distributors who invest a huge sum of money for the making of each movie.

Sometimes when a box-office movie is released, people may be busy with work or may have traveled out-of-country for a business meeting. If people miss out when the movie is released, they have to only wait for the CD/DVD of the movie to be released before they can watch their favorite movie.

Some live shows occur only in bigger cities. Also only box-office movies are released in all the theatres, many small budget movies either are not shown in all theatres or they may be shown only for fewer days. This causes a lot of discomfort for people not living in major cities. They would really like to see the movie but are unable to do so because they may have to travel long distances, in some cases make out-of-station travels to see a particular movie/event.

Accordingly, there is a need for a system for to present live entertainment to people so that they can directly receive and enjoy the movie/event from the comfort of their home. Also there is a need for a system that is secure, reliable and easy to use.

### SUMMARY OF THE INVENTION

In view of the foregoing disadvantages inherent in the prior art, the general purpose of the present invention is to provide a live entertainment to people at home for any movie/event and to include all the advantages of the prior art, and also to overcome the drawbacks inherent therein.

The present invention takes movie/live non-free stage entertainment shows to the comfort of viewers home. The viewer can privately enjoy the live show with his/her family members at home.

The present invention provides flexibility to the viewer to watch the movie/live non-free stage entertainment shows at his/her own convenient time in a day. The user chooses his/her own preferred date and time (e.g., anytime in 24 hours instead of predefined timings) at the time of ticket booking. This helps, as user no longer has to adjust the daily schedule to catch the movie/event.

The present invention encourages people to watch newly released movie/event in all weather conditions. The user can book the required number of tickets online and can enjoy the movie/live non-free stage entertainment shows without even stepping out of their home. This aspect of the present invention greatly increases revenue for movie producers and distributors. The present invention eliminates most of the traveling needed to watch entertainment.

These together with other aspects of the present invention, along with the various features of novelty that characterize the present invention, are pointed out with particularity in the claims annexed hereto and form a part of the present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 illustrates the overall architecture diagram of present invention;

FIG. 1.A illustrating a method for streaming the live digital content of entertainment to Television with internet connection in accordance with an embodiment of the present invention;

FIG. 1.B illustrating a method for streaming the live digital content of entertainment to personal computer in accordance with an embodiment of the present invention;

FIG. 1.C illustrating a method of extending the streaming live digital content of entertainment from personal computer to external interactive display device i.e., Television in accordance with an embodiment of the present invention;

FIG. 1.D.a illustrating an electronic ticket sent from the present invention to viewer's email address after the ticket booking.

FIG. 1.D.b illustrating a reminder notification sent from the present invention to viewer's cell phone (i.e., SMS) and email address (e-mail message) before the event starts.

FIG. 2 is block diagram of an event booking system of present invention.

FIG. 3 is illustrating a web interface component of booking module in accordance with an event booking system of present invention.

FIG. 4 is illustrating an event ticket with authentication code generated by the present invention.

FIG. 5 is illustrating a method for prompting the access code to validate the credentials of the viewer in accordance with an embodiment of the present invention.

FIG. 6 is a flow chart illustrating a method for ticket booking and generating the authentication code in accordance with an embodiment of the invention

FIG. 7 is a flow chart illustrating a method for validating the authentication code while event is taking place in accordance with an embodiment of the invention

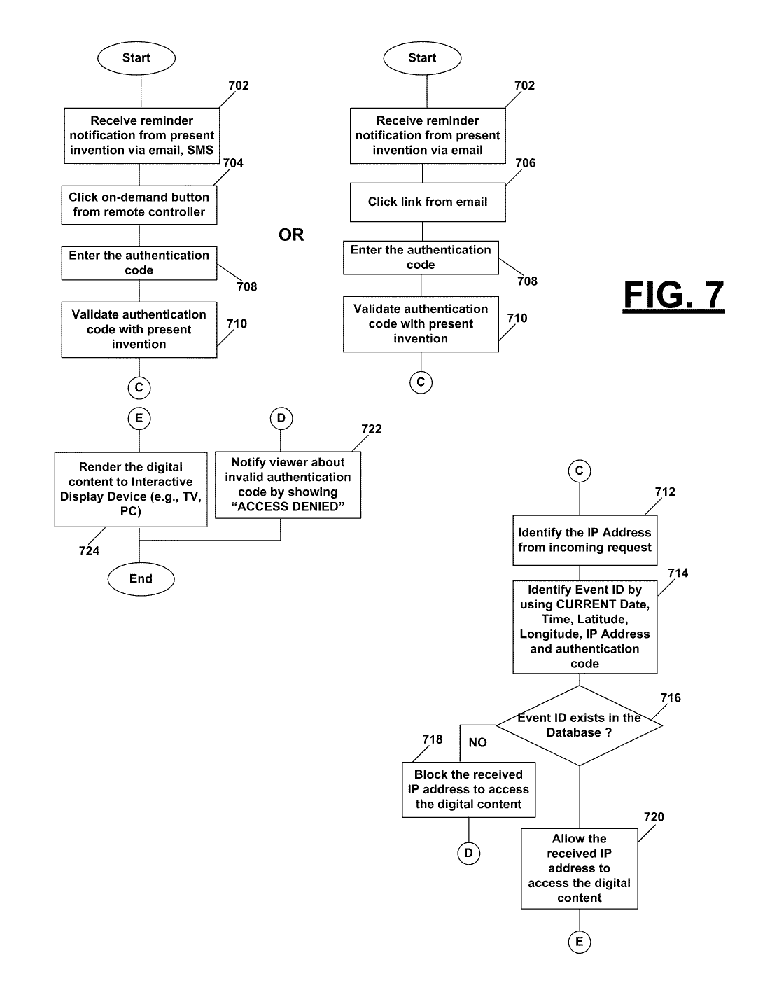

### DETAILED DESCRIPTION OF THE INVENTION

The exemplary embodiments described herein detail for illustrative purposes and are subject to many variations in structure and design. It should be emphasized, however, that the present invention is not limited to a particular method to watch live event digital content from theater, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The terms “a” and “an” herein do not denote a limitation of quantity, but rather denote the presence of at least one of the referenced item.

The present invention discloses a method and system for providing live digital content of entertainment at home though interactive display electronic devices like television, personal computer. Thereby, present invention allows viewers to relax and enjoy the newly released movie privately at their home.

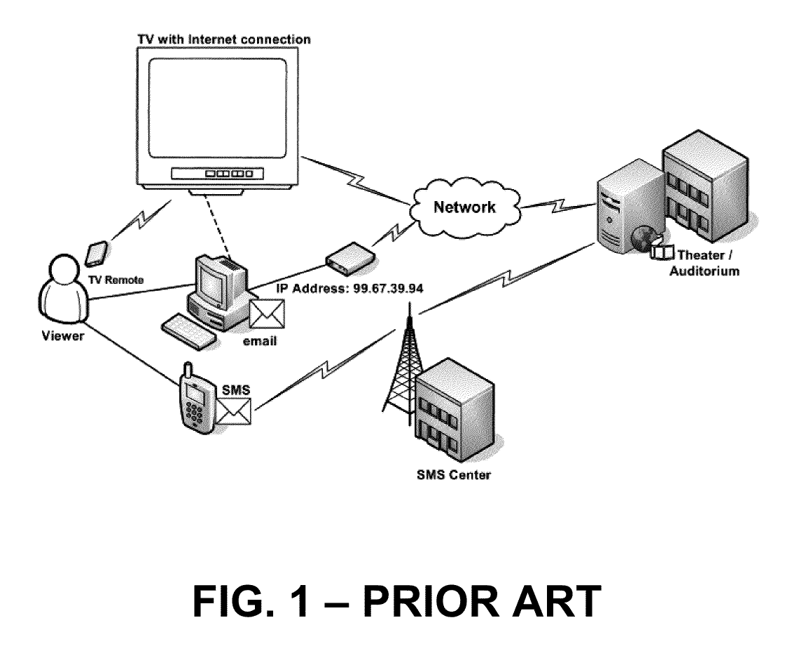

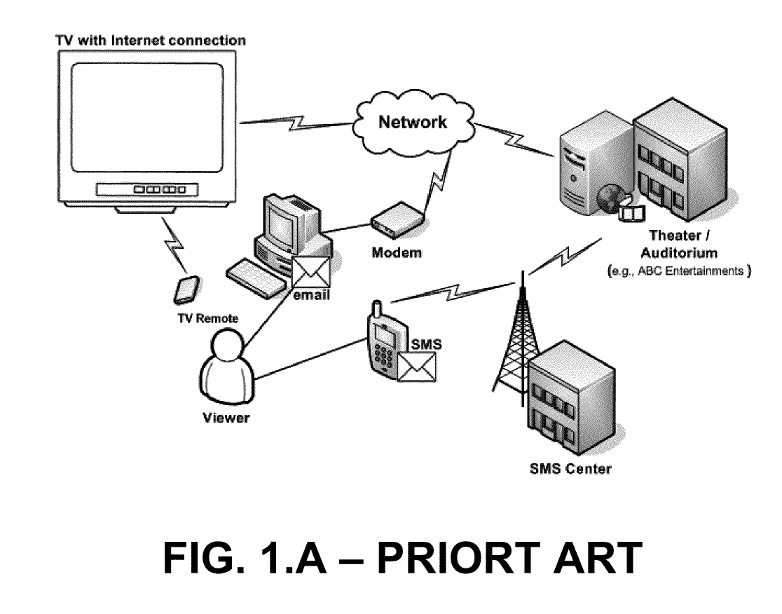

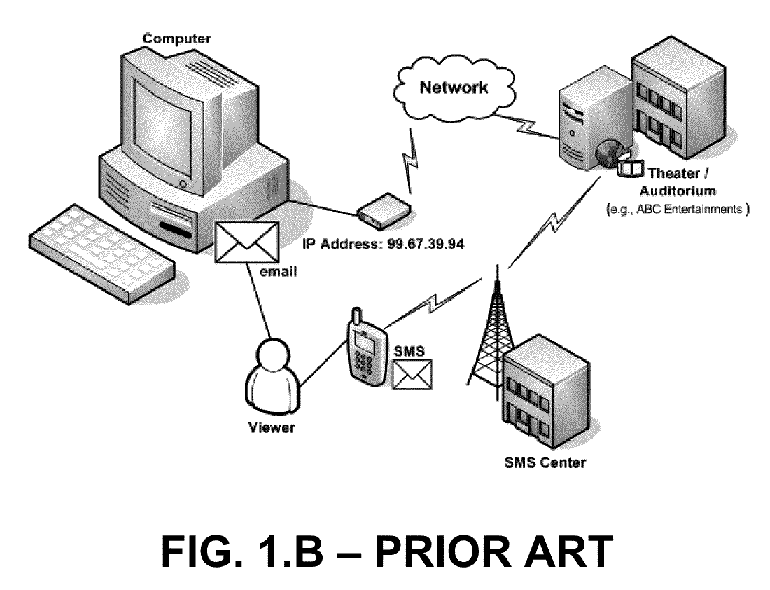

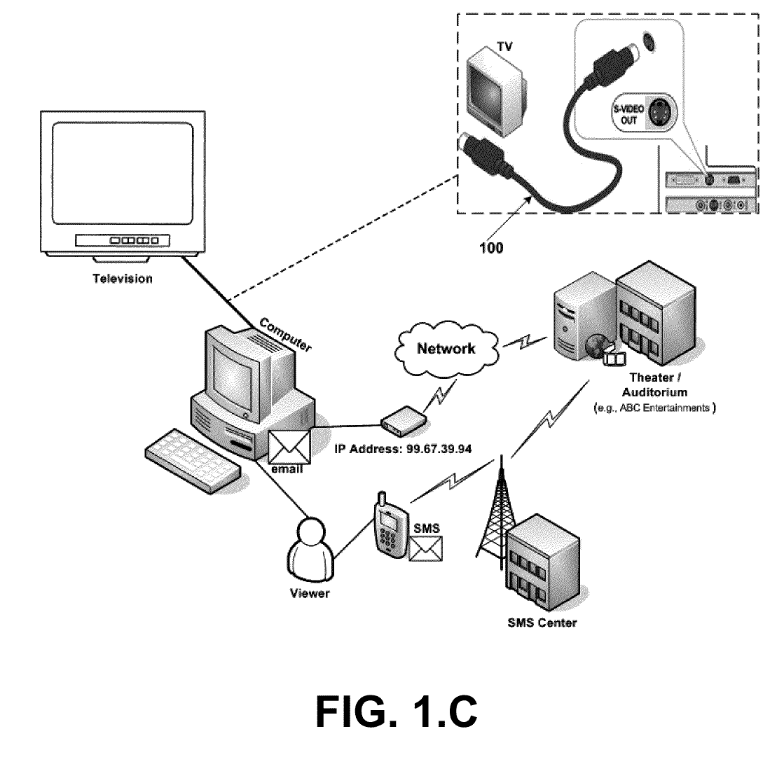

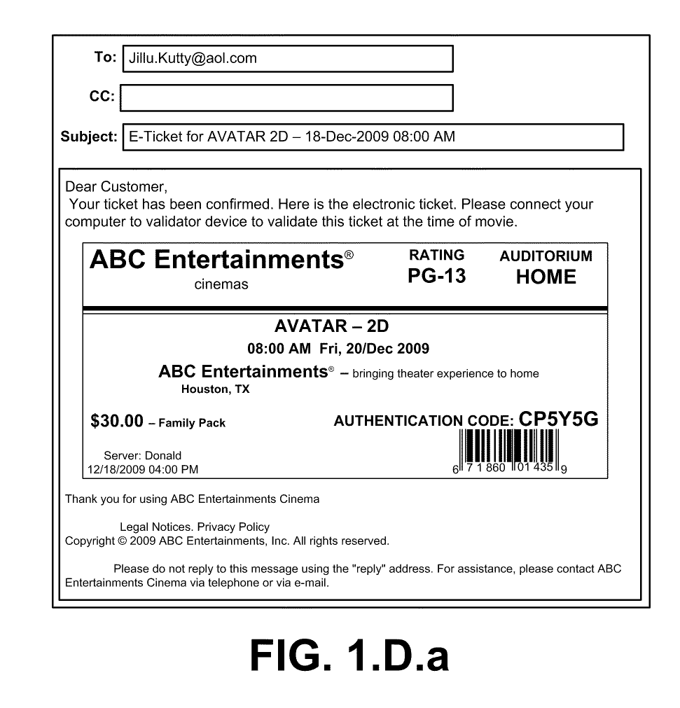

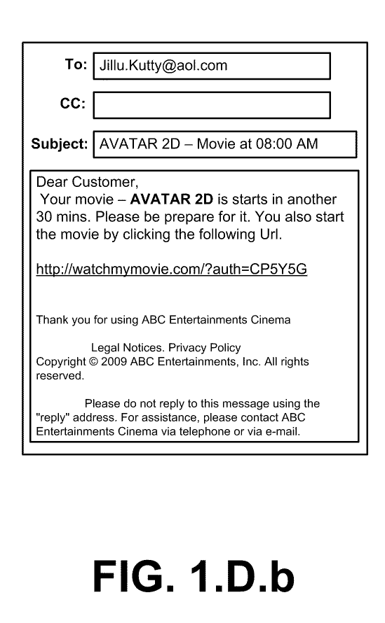

Referring to FIG. 1, shows the overall architecture diagram of the present invention. FIG. 1.A illustrates the first embodiment of the present invention that provides live digital content from theater/auditorium to TV with Internet connection. Reports have it that Philips is rolling out its all new NET TV, a HDTV which will be the part of Philips 8000 and 9000 and Cinema 21:9 series. Such an electronic device is used as an Interactive display device for streaming digital content of live event like movie/non-free stage entertainments. FIG. 1.B illustrates the second embodiment of the present invention that streaming live digital content of event to personal computer. Where personal computer is closely connected to modem to get an internet connection and each viewer has unique Internet Protocol Address (IP Address). The present invention uses this unique key to generate the authentication code for validation.

As shown in FIG. 1.C, viewer can extend the digital output of personal computer to Television via cable 100. Personal computer has a Video card with a TV-OUT connector. The connection will normally be integrated in video card and located at the back of personal computer as shown FIG. 1.C. Also, similar video card connector cables are available for laptop. The TV-OUT connector cable is pluggable between the TV and personal computer/laptop and links them to each other. The cable indicates which line goes in and which one goes out, so that viewer plugs IN their TV sent OUT from their personal computer.

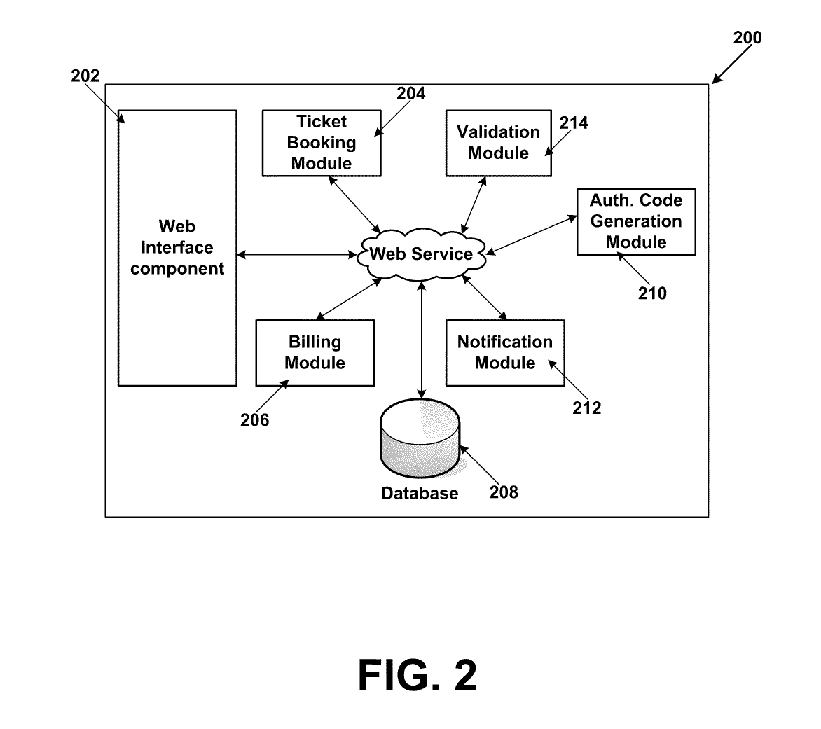

Referring to FIG. 2, a block diagram of the system of the present invention 200, hereinafter referred to as system 200, is illustrated. The system 200 is composed of separated components: the web interface component 202, Ticket Booking Module 204, Billing Module 206, Database 208, Authentication Code Generation Module 210, Notification Module 212 and Validation Module 214. Each component of the system is communicated through interoperable layer to leverage the Service Oriented Architecture benefits.

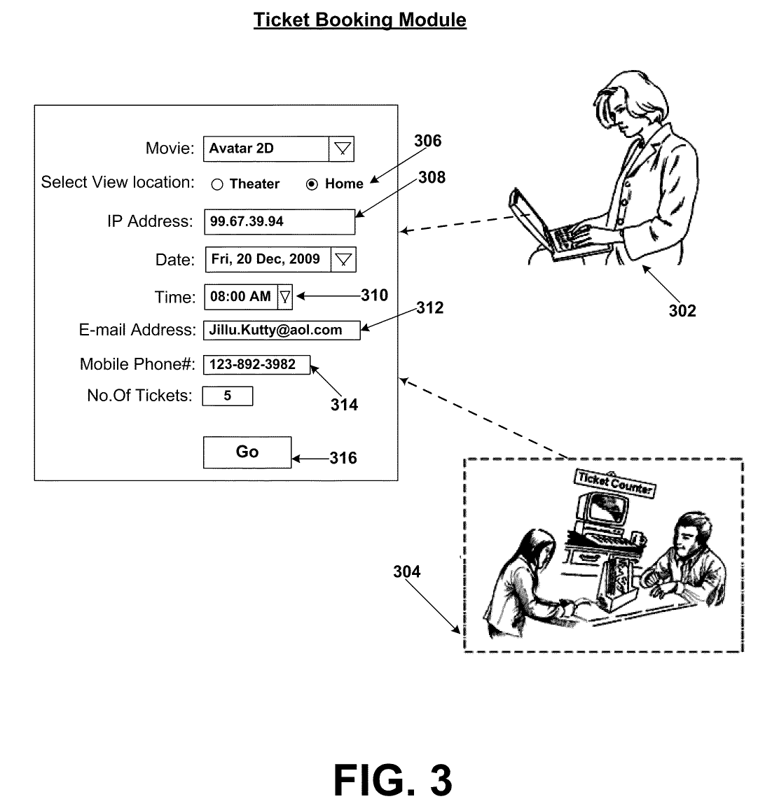

As shown in FIG. 3, the present invention provides the web interface component where viewer books the ticket through it. The web interface component provides a facility to select movie name, view location, date and time as preferred by the viewer. The main objective of the present invention is bringing the theater experience to home. So, viewer books the required number of tickets through the web interface component of present invention from their own home as shown in 302 or they can book the tickets at ticket counter as shown in 304. If viewer wishes to enjoy the home experience but happens to be at the ticket counter and is unaware of his home IP address, the customer support executive recommends them to book it through the online web interface. So that the present invention automatically populates the viewer's IP address 308 when they enter into web interface component.

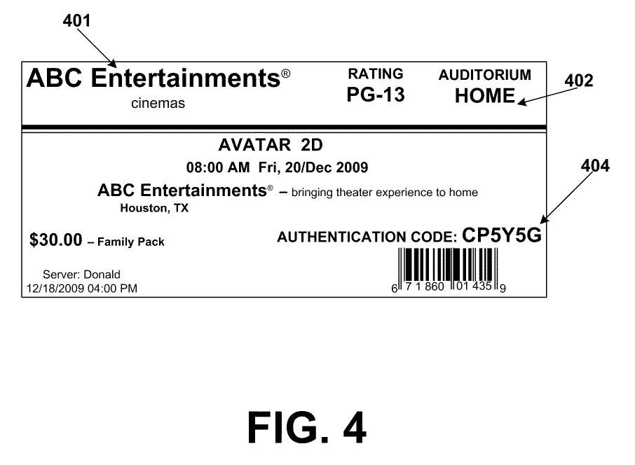

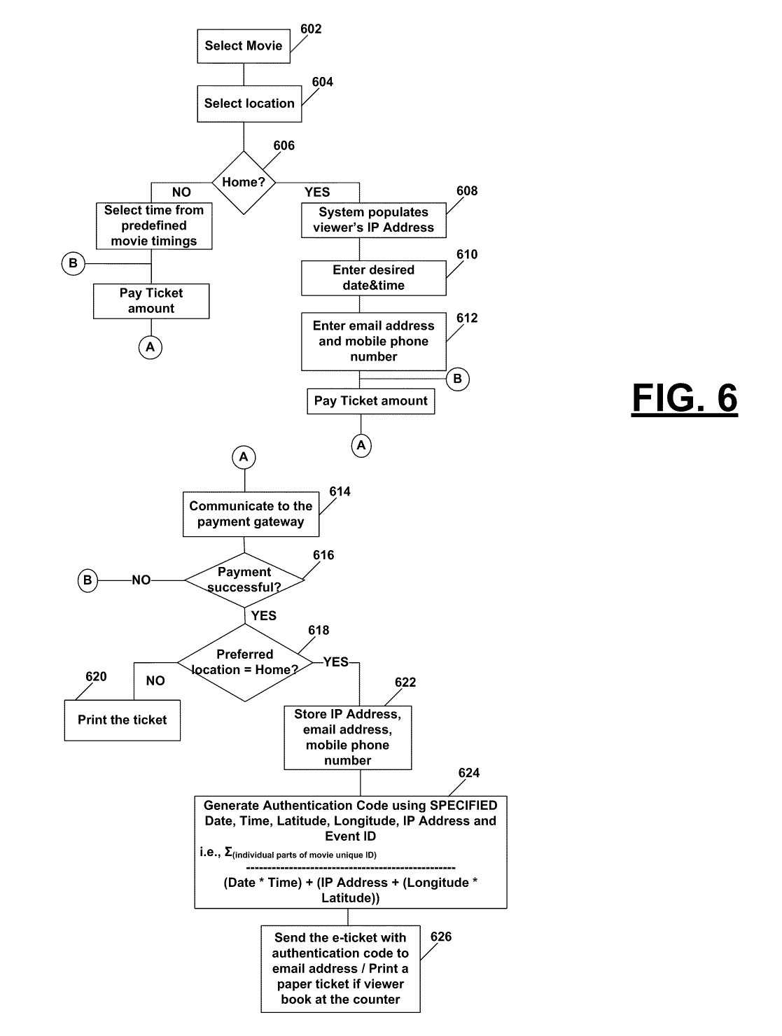

Viewer selects the movie and their desired location to watch the movie. If viewer selects theater as their desired location to watch, system performs normal operation as today's ticket booking system as shown in FIG. 6. If viewer selects home as their desired location to watch, the present invention pre-populates the IP address in the corresponding text box 308. Also, the web interface component provides a facility to select viewer's desired date and time 310. They can select any date and time (e.g., anytime in 24 hours instead of predefined timings). Thus the present invention increases the revenue and it helps the film producers as well as the distributors who invest a huge sum of money for the making of each film. The web interface components provides the fields to enter their email address 312 and phone number 314 where system sends a reminder notification to viewer. After the viewer enters the necessary details he/she can purchase the tickets by pressing ‘Go’ button 316. The present invention communicates with the payment gateway for further billing process as shown 614 of FIG. 6 If it is successful then system stores the entered data of viewers to database and generates the authentication code as shown in 624 of FIG. 6 and sends an e-ticket to their email address. FIG. 1.D.a illustrates an e-ticket sent from the present invention to viewer's email address and FIG. 4 illustrates the paper ticket which generated by the present invention which has view location 402 and authentication code 404.

In operation, as shown in FIG. 3, the viewer buys ticket(s) either by going online or at the ticket counter. When viewer buys ticket(s) through online or ticket counter, the present invention provides a web interface component to gather the information from viewer which includes their preferred location, movie, IP address, date and time (e.g., anytime in 24 hours instead of predefined timings). A viewer chooses their desired location either in Theater or Home to watch the movie/event. If viewer chooses Home as their desired location, the web interface component of present invention automatically populates his/her IP address and viewer chooses their desired date and timings (e.g., anytime in 24 hours instead of predefined timings) to watch the event like movie/non-free stage entertainment. After viewer enters the necessary information and places an order to buy the ticket, then the present invention stores the information of viewer and corresponding Event ID in the database. Generally, all movie names are stored in the database in the form of UUID (Universally Unique Id). The intent of UUIDs is to enable the present invention to uniquely identify the movie information without significant central coordination. So, each and every movie name is stored with its corresponding 128 bit number. Once this information is stored in the database the present invention then generates an authentication code based on viewer's IP address, SPECIFIED date, and time and then provides a ticket with authentication code.

In some scenario, if viewer does not know their IP address then the customer service at the auditorium/theater recommends the viewer to book a ticket through online, so that the web interface component automatically determines the viewer's IP address and generates the authentication code based on their IP address. The generated authentication code is then sent to the viewers email address as shown in FIG. 1.D.a. As shown in FIG. 1.D.b, the present invention also sends a reminder notification to the viewer's cell phone (i.e., SMS Text message) and email address (e-mail message) before the event (i.e., movie/non-free stage entertainment) starts.

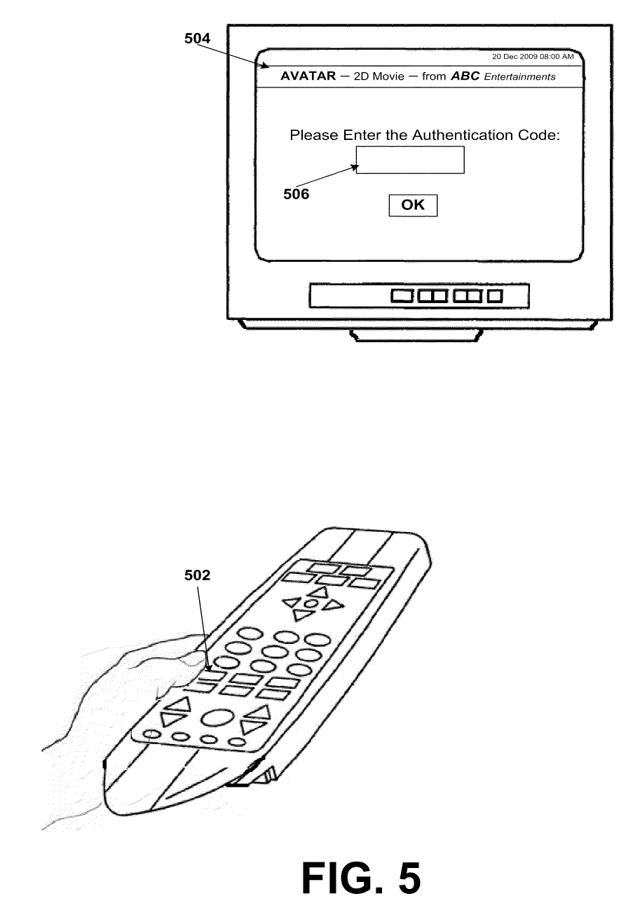

In embodiment as shown in FIG. 1.A, the present invention works with TV and the Internet connection. Viewer clicks on “On-demand” button 502 on their TV remote as shown in FIG. 5, and then viewer selects the booked movie 504 from the pre-populated list. The present invention then authorizes the viewer by prompting for the authentication code 506. Viewer enters the authentication code from their purchased ticket (e-ticket or paper ticket) and clicks ‘OK’ button to initiate the validation request. Viewer's TV with Internet connection sends a request to the system of present invention with IP address, CURRENT date, time (only hour without minutes) and the authentication code. The system determines the Event ID (i.e., UUID) based on the incoming request information. If system is not able to find Event ID based on the incoming IP address and authentication code then system notifies the viewer with error message “Access Denied. Check Authentication code or make the selected movie is for current date and time”. If system is able to find the Event ID, the system allows the incoming IP request to access the live digital content and the corresponding digital content starts streaming to viewer's interactive display device. The live digital content includes the copyrights from the movie distributor, so that viewer cannot save the digital content from the TV. Also, if viewer starts to watch the live digital content using a specific authentication code, they cannot watch the movie again with same authentication code; because once the specified date and time expires the authentication code expires automatically.

In another embodiment as shown in FIG. 1.B, the present invention works with personal computer with modem. Viewer receives a notification message (as shown in FIG. 1.D.b) to the provided email address; by clicking on the link from email message, the digital content of event like movie or non-free live stage entertainment starts streaming into their default media player once the request is validated. Thus, viewers watch the digital content using media player like Windows Media Player, Real Player, DivX, etc from their personal computer.

In another embodiment of the present invention as shown in FIG. 1.A, the present invention allows viewer to integrate the digital content output from their personal computer to external monitor or Television using the TV-OUT cable.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application. Although the present invention has been described with reference to particular embodiments, it will be apparent to those skilled in the art that variations and modifications can be substituted without departing from the principles and spirit of the invention.

I claim:

1) An entertainment system for providing live digital content of event presented in a room or hall, fitted with tiers of seats rising like steps, to home viewers, said an entertainment system streaming the live digital content of event to an interactive display electronic device, said entertainment system comprising:
a web interface component to collect the information about viewer's preference, the collected information includes a location to watch the event, convenient date and time, IP address, email address, telephone number;
a ticket booking module to store the collected information to relational database;
a billing module to communicate to the payment gateway to process the payment for the event ticket;
an authentication code generation module to generate the unique identification id for ticket using arithmetic calculation, the arithmetic calculation includes IP address, geographic coordinate of the viewer computed from numeric sequence of viewer's Internet server, convenient date and time of viewer and event identifier;
a notification module to send reminder notification to specified email address and mobile number as electronic mail message and Text message respectively;
a validation module to confirm the identity of ticket from incoming request by obtaining the event identifier using received authentication code, IP address, geographic coordinates of the viewer location computed from received IP address, current system date and time.

2) The entertainment system according to claim 1, wherein the electronic device is a television set.

3) The entertainment system according to claim 1, wherein the electronic device is a personal computer, laptop.

4) The entertainment system according to claim 1, wherein the event is a motion-picture show.

5) The entertainment system according to claim 1, wherein the event is a non-free stage entertainment live show.

6) A method to generate the identity of a viewer by defining the hexadecimal code using the numerical sequence that serves as an identifier for an Internet server of viewer, specified date and time and event identifier, said method comprising the steps of:
collecting numerical sequence that serves as an identifier for an Internet server of viewer;
defining the location of the viewer's geological coordinates on Earth using said in step of numerical sequence;
generating the identity for ticket by arithmetic calculation using numerical sequence as said in step of collecting numerical sequence, geographic coordinate of the viewer's location computed from said numerical sequence, SPECIFIED convenient date and time of viewer and event identifier;
said method confirming the identify of ticket comprising the steps of:
initiating the validation of ticket identify by entering the authentication code from ticket;
receiving web request with authentication code and numerical sequence of an internet server of the requester;
obtaining the location of incoming request using received numerical sequence of an internet server of the requester;
obtaining the event identifier by arithmetic calculation using said in step of received numerical sequence from received incoming web request, geographic coordinate of requester's location computed from said numerical sequence, CURRENT computer date and time.

7) The method according to claim 6, wherein said geographic coordinates are longitude and latitude.

8) The method according to claim 6, wherein said convenient date and time of viewer is the data which entered in said web interface component as preferred date and time to watch the live digital content of said event.

9) The method according to claim 6, wherein CURRENT computer date and time is date and time of computer where the entertainment system software resides.

10) The method according to claim 6, wherein said numerical sequence is an Internet Protocol (IP) address that serves as an identifier for an Internet server of viewer.

11) A method allowing the viewer to watch the live said event at their convenient time in a day, said method allowing the viewer to enjoy the live digital content of said event with their family members privately in their home, said method providing a solution for piracy by transmitting the copyrights statement with live digital content of said event, said method comprising the steps of:
booking the tickets through web interface component;
selecting home location as preferred event watch location;
entering convenient date and time;
entering email address, phone number for reminder notification;
generating authentication code by said an entertainment system using said numeric sequence of an Internet server of viewer, geographic coordinate of viewer's location computed from said numeric sequence of an Internet server of viewer, convenient date and time of viewer and event identifier and providing ticket to the viewer;
sending reminder notification to cell phone, email address of viewer before starting the said event;
triggering the event by pressing on-demand button in the TV remote controller or clicking the link from email address to watch the digital content in personal computer;
prompting for authentication code;
entering authentication code from the ticket to initiate the validating authentication code with the system database;
obtaining the event Identifier from incoming request using said numeric sequence of an Internet Server, computed geographic coordinate of the requester using said numeric sequence of an Incoming Internet Server, authentication code, CURRENT computer date and time;
allowing incoming Internet Server of requester to access the digital content of an said event if event identifier is found in step obtaining the event identifier and streaming the digital content of said event to requester's interactive display device;
blocking incoming Internet Server of requester to access the digital content of an said event if event identifier is not found in step obtaining the event identifier and notifying the requester as access denied;

12) The method according to claim 11, wherein said find the event identifier in the database comprising the steps of finding an equivalent identifier for obtained event identifier as said in the step of obtaining the event Identifier.
